(19) United States
(12) Patent Application Publication
(10) Pub. No.: US 2008/0098196 A1
(43) Pub. Date: Apr. 24, 2008

(54) INFORMATION PROCESSING APPARATUS AND INFORMATION PROCESSING METHOD

(75) Inventor: Hisaya Miyamoto, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/873,795

(22) Filed: Oct. 17, 2007

(30) Foreign Application Priority Data
Oct. 20, 2006 (JP) 2006-286577

(51) Int. Cl. G06F 12/10

(52) U.S. Cl. 711/203; 711/202; 711/E12.058

(57) ABSTRACT

The information processing apparatus includes a CPU, a memory connected to the CPU 2 via a bus, an external device configured to perform predetermined processing, an MMU, and a DMAC. The DMAC transfers input data from the memory based on a physical address of the memory set as a physical address of the input data, and output data to the memory based on a physical address of the memory set as a physical address of the output data. The external device obtains from the MMU a physical address corresponding to a virtual address of target data, and obtains from the MMU a physical address corresponding to a virtual address of result data. The external device sets the obtained physical addresses of the target data and the result data as physical addresses of the input data and the output data, respectively.

### CROSS REFERENCE TO RELATED APPLICATION

This application is based upon and claims the benefit of priority from the prior Japanese Patent Application No. 2006-286577 filed on Oct. 20, 2006; the entire contents of which are incorporated herein by reference.

### BACKGROUND OF THE INVENTION

1. Field of the Invention

The present invention relates to an information processing apparatus and an information processing method, and more specifically to an information processing apparatus configured to perform predetermined processing by using an external processing device and an information processing method for the same.

2. Description of the Related Art

As processes have become more and more complicated in an application program (hereinafter simply referred to as a program) and the like executed on a computer, a part of processing performed by a central processing unit (hereinafter referred to as a CPU) is more and more performed on behalf of the CPU by an external processing device (hereinafter referred to an external device) such as another CPU, a dedicated chip or the like. For example, this applies to a case where an external device is requested to handle particular processing, such as image processing among other processes in an application program. For an application program in such a case, a programmer focuses on the points below.

First, when target data to be processed by the external device is data on a main memory, a programmer focuses on the fact that predetermined processing needs to be performed by an external device once an inconsistent state (an incoherent state) between a cache and the main memory is eliminated. As implementation of a cache snoop function has become a common practice, it is no longer so important to eliminate the incoherent state between the cache and the main memory as before. When predetermined processing is to be requested to an external device, however, there are various kinds of overheads including the task as described above.

Execution of each program is managed by an operating system (hereinafter referred to as an OS) based on a virtual address in a corresponding process space. The virtual address is mapped on a real address, i.e., a physical address by a memory management function of the CPU.

Thus, second, the programmer focuses on the association between the virtual address and the physical address and how to manage a virtual address in a process space. For example, consider that target data to be processed is stored in relatively large buffer areas defined on the main memory. Here, it is a program running on the CPU that is managing the buffer areas. The buffer areas are referenced or updated from the program as continuous areas from a viewpoint of virtual addresses. The continuous areas from a viewpoint of virtual addresses are not necessarily continuous from a viewpoint of physical addresses.

The memory management function of the CPU manages not only association between the virtual address and the physical address but also the access authority of a program to the virtual address. Generally, an external device that operates based on the physical address is independent of the memory management function of the CPU, however, and the external device can write data even in a memory area into which the memory management function of the CPU prohibits writing. Therefore, the programmer needs to focus on the fact that the memory management function of the CPU cannot control operations of the external device.

The abovementioned second point will be described in detail with reference to an example. For example, a certain external device has a dedicated DMAC (direct memory access controller), and the external device reads a data string of target data from a specified area in the main memory through DMA (direct memory access) and performs predetermined processing on the data string. Then, the external device outputs, again through the DMA, the data string subjected to the predetermined processing or data resultant of some processing to the specified area in the main memory. Although the series of processing steps seem simple, they actually require complicated procedures.

When a series of pieces of data to be processed are present discontinuously in a physical space, the series of pieces of data need to be copied to another buffer area, which is continuous in the physical space, before the DMA is performed. That is for making the series of pieces of data present at continuous physical addresses by the copy processing. The copy processing is performed by a software program process running on the CPU, such as memcpy function.

As a result, the DMAC of the external device can read target data to be processed from the buffer area, which is continuous in the physical space, by the DMA, and output its processed result of the predetermined processing to other predetermined buffer area, which is continuous in the physical space, by the DMA.

Then, the completion of the predetermined processing in the external device is notified to the CPU through an interruption. The CPU executes a program that performs post-processing after the predetermined processing has been performed by the external device, in response to the interruption. In the post-processing, the data resultant of the processing output to the abovementioned other buffer area is copied to other buffer area indicated by a virtual addresses in the process space specified by the program, since the buffer in the process space could be discontinuous in the corresponding physical space. The copy processing is also performed by a software program process running on the CPU, such as memcpy function. With the post-processing, the program running on the CPU can use the result output from the external device.

In the above instance, when the external device is used, there is the processing for a software program running on the CPU to copy the target data to be subjected to predetermined processing in the external device and to copy the result of the processing of the external device in order to refer from the software program. Therefore, there is overhead according to the amount of the target data and the amount of the result data. The more the amount of data, the larger the overhead increases.

In the above instance, in addition to the overhead, there is another concern in protecting a memory with respect to the processing by the external device having a dedicated DMAC. Generally, a program running on a CPU is limited in its execution and memory access based on virtual addresses in a process space managed by an MMU (memory management unit) of the CPU. A code area, in which a program is written, is managed by the MMU using an attribute of writing prohibition so that the code of the program is not destroyed by the running away program.

The external device that directly references or updates the physical space, however, performs memory access to the main memory without regard of the management by the MMU. Therefore, the data can be output to an area protected by the MMU if the external device is incorrectly set. Thus, if the external device is incorrectly set, an operation of the external device can destroy a code or data that should be protected.

Then, as a mechanism of protecting particular data and code arranged on the main memory, a mechanism other than general mechanisms as functions in the MMU is proposed in the Japanese Patent Laid-Open No. 2000-20401.

With the mechanism according to the proposal, a writing operation to an address on a particular memory is monitored and excluded. In case where a program running on a certain system is predefined and its placement on the main memory is not dynamically changed, the mechanism according to the proposal for monitoring and excluding the writing operation to an address on a particular memory is somewhat effective. However, an OS of the UNIX system that has also been widespread in an embedded environment dynamically controls placement, generation and extinction of the program to be executed. That is why the mechanism according to the proposal cannot be applied to such an OS. Such an OS uses a function of the MMU to protect particular data and code arranged on the main memory with a memory management software program as supplement to the MMU function. Specifically, when the MMU supplies a physical address to the CPU, the MMU also supplies protection information including whether or not writing is prohibited for the area. Therefore, in a system having such an OS installed, a well-known technique, the MMU and a memory management software program of an OS are sufficiently functioning as a mechanism of protecting data and a code arranged on the main memory no matter how the throughput of the entire system.

A mechanism of implementing processing of the external device based on the virtual address is also proposed in Japanese Patent Laid-Open No. 09-81720, for example. According to the proposal, an image processing device with a dedicated DMAC has a dedicated local bus with a bus converter provided between the local bus and a main bus, to which the main memory and the CPU are connected. The bus converter is provided with a dedicated MMU for an expansion bus for converting a virtual address into a physical address.

As in the case of the abovementioned OS of the UNIX system, however, when placement, generation and extinction of a program to be executed is dynamically controlled and it is not possible to know what virtual address (correctly, a virtual address in a process space) at which the program running on the OS is to be generated and what physical address to which the virtual address specifically corresponds, it is generally difficult for the mechanism according to the proposal to set a virtual address of a memory area used by the program and a corresponding physical address to the MMU for the expansion bus.

In case of the mechanism according to the proposal, the memory area used by the program can be discontinuous in a management unit of the MMU (generally referred to as a page) from a viewpoint of actual physical address even if the memory area is continuous from a viewpoint of virtual address. It is disadvantageous, therefore, that association between necessary virtual addresses and physical addresses needs to be completely set to the MMU for the expansion bus before the DMAC of the external device starts operating.

As mentioned above, in the case of a program whose part of processing, which would have been performed by a CPU, is performed on behalf of the CPU by an external processing device, a series of pieces of data to be processed which is indicated by a virtual address in a process space can be arranged discontinuously in a physical space. Thus, the series of pieces of data need to be copied in an area continuous in the physical space. In addition, the result output of predetermined processing in the external device needs to be copied from an area continuous in the physical space to an area identified by a virtual address in a process space. As the amount of load of copy processing on the CPU depends on the amount of data to be copied, overhead including copying processing in using such an external device may lower the performance of the entire system including the CPU. An API that changes operational modes of a program by exception handling and a driver routine program that performs various types of setting on the external device are dedicated for the external device. Thus, there has been a problem in that a new software program needs to be developed.

### SUMMARY OF THE INVENTION

An aspect of the present invention can provide an information processing apparatus including: a central processing unit; a memory connected to the central processing unit via a bus; an external processing device connected to the central processing unit and the memory via the bus and configured to execute predetermined processing; an address converting unit configured to output a physical address of the memory corresponding to a virtual address of a process to be executed in the central processing unit when the virtual address is input; a transferring unit provided in the external processing device, the transferring unit being configured to perform data transfer of input data from the memory based on the physical address of the memory set as the physical address of the input data and perform data transfer of output data to the memory based on the physical address of the memory set as the physical address of the output data; a physical address obtaining unit configured to obtain the physical address corresponding to the virtual address of target data of the predetermined processing from the address converting unit and obtain the physical address corresponding to the virtual address of result data of the predetermined processing from the address converting unit; and a setting unit configured to set the physical address of the target data and the physical address of the result data obtained by the physical address obtaining unit as the physical address of the input data and the physical address of the output data for the data transferring unit, respectively.

An aspect of the present invention can provide an information processing method in an information processing apparatus having a central processing unit, a memory connected to the central processing unit via a bus, an external processing device connected to the central processing unit and the memory via the bus and configured to execute predetermined processing, an address converting unit configured to output a physical address of the memory corresponding to a virtual address when the virtual address of a process to be executed in the central processing unit is input, and a transferring unit provided in the external processing device, configured to perform data transfer of input data from the memory based on the physical address of the memory set as the physical address of the input data and perform data transfer of output data to the memory based on the physical address of the memory set as the physical address of the output data; the method including: obtaining the physical address corresponding to the virtual address of target data of the predetermined processing from the address converting unit; obtaining the physical address corresponding to the virtual address of result data of the predetermined processing from the address converting unit; setting the physical address of the obtained target data and the physical address of the result data respectively as the physical address of the input data and the physical address of the output data; performing by the transferring unit data transfer of the input data from the memory based on the physical address of the memory set as the physical address of the input data; and performing by the transferring unit data transfer on the output data to the memory based on the physical address of the memory set as the physical address of the output data.

### BRIEF DESCRIPTION OF THE DRAWINGS

FIG. 1 is a configuration diagram showing configuration of an information processing apparatus according to an embodiment of the present invention;

FIG. 2 is a diagram for illustrating a flow of processing by an external device in the information processing apparatus according to the embodiment of the present invention;

FIG. 3 is a diagram for illustrating a flow of processing by an external device in the information processing apparatus according to the embodiment of the present invention;

FIG. 4 is a diagram for illustrating a flow of processing by an external device in the information processing apparatus according to the embodiment of the present invention;

FIG. 5 is a diagram for illustrating a flow of processing by an external device in the information processing apparatus according to the embodiment of the present invention;

FIG. 6 is a configuration diagram showing configuration of the information processing apparatus with a main memory and an interruption controller omitted for illustrating configuration of an MMU according to the embodiment of the present invention;

FIG. 7 is a diagram showing a format of information to be registered in each entry part of a TLB according to the embodiment of the present invention; and

FIG. 8 is a diagram showing each content of information to be registered in a PageMASK register 43, an EntryHi register 44, an EntryLo0 register 45, and an EntryLo1 register 46 according to the embodiment of the present invention.

### DETAILED DESCRIPTION OF THE PREFERRED EMBODIMENT

Hereinafter, an embodiment according to the present invention will be described with reference to the drawings.

(Configuration of Apparatus)

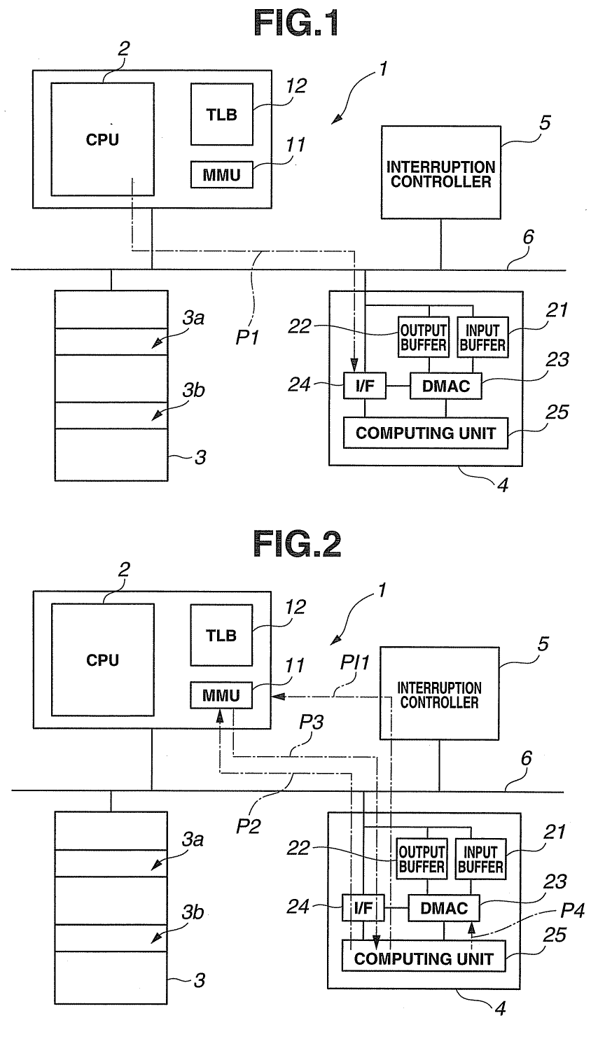

First, referring to FIG. 1, configuration of an information processing apparatus according to the embodiment will be described. FIG. 1 is a configuration diagram showing the configuration of the information processing apparatus according to the embodiment.

As shown in FIG. 1, the information processing apparatus 1 includes a CPU 2, a main memory 3, an external device 4, and an interruption controller 5. The CPU 2, the main memory 3, the external device 4 and the interruption controller 5 are connected with each other via a bus 6. The CPU 2 expands a program read out from a ROM or storage (not shown) in the main memory 3 and executes the program. When the CPU 2 executes the program, a code to be executed and data to be processed is identified by a virtual address in a process space is specified. At that moment, the CPU 2 can inquire of a memory management unit (hereinafter referred to as an MMU) 11 a physical address of the main memory 3, which is a memory such as a RAM, corresponding to a code to be executed and data to be processed, and read the code or the data from the main memory 3 based on the physical address obtained in response to the inquiry for execution or processing. Then, as described later, an external device 4, which is an information processing apparatus other than the CPU 2, may execute a part or all of one or more programs executed on the CPU 2.

The MMU 11 is connected to the CPU 2 and the bus 6. The MMU 11 is also connected to a TLB (Translation Look-aside Buffer) 12. The TLB 12 includes a correlation table in which information on correlation between a virtual address and a physical address is stored. In the TLB 12, information on correlation between a virtual address and a physical address, and management information on a virtual page are registered.

Memory management in the TLB 12 is performed by the unit of ‘page’ with a certain size. In the TLB 12, management information is recorded in addition to a virtual address of the top of the page (sometimes a process ID to be described later is included) and a physical address corresponding to the virtual address. The management information includes information on a page size and a page attribute of the virtual page. The information on the page attribute includes a feature of D-cache, information on permission and the like. The information on permission is information including an execution authority, an access right, and an alteration right of a virtual address or a virtual space of a process. The execution authority is for whether or not to execute a code. The access right is for whether or not to access a code or data. The alteration right is for whether or not to alter a code or data. A memory manager program included in an OS (not shown) performs setting of data on association between a virtual address and a physical address in the TLB 12 and management of resetting and the like.

The MMU 11 supplies the physical address and the management information by referencing the TLB 12 in response to the inquiry from the CPU 2 about the physical address. Specifically, when the virtual address of the process is input, the MMU 11 forms an address converting unit configured to output the physical address of the main memory 3 corresponding to the virtual address and the management information. The MMU 11 supplies the correlation information between the virtual address and the physical address to the CPU 2. If data on the virtual address relating to the inquiry is not present in the TLB 12, the CPU 2 make a transition to exceptional state. The exceptional state triggers the memory manager program running on the CPU 2 to update the contents of the TLB 12. As described later, in response to the inquiry from the external device 4 about the physical address, the MMU 11 also supplies the physical address and the management information to the external device 4.

Therefore, the MMU 11 supplies the management information on the virtual page as well as the information on the physical address to the CPU 2 or the external device 4.

The main memory 3 is a storage device accessed by the CPU 2 and the external device 4. When the main memory 3 is accessed by the CPU, a program running on the CPU specifies the virtual address. The virtual address is converted into a physical address by the MMU 11. The physical address specifies a location of a code or data.

The external device 4, which is a bus master, is a device, a logic circuit and the like including a CPU that has a function of executing predetermined processing. The external device 4 includes an input buffer 21, an output buffer 22, a DMAC 23, an interface (hereinafter referred to as an I/F) 24 and a computing unit 25.

The input buffer 21 and the output buffer 22 are connected to the bus 6 and the DMAC 23. Although the input buffer and the output buffer are provided independently in the embodiment, the input buffer 21 and the output buffer 22 may be provided as one buffer if only that buffer has two areas inside. Even in the case of one buffer, the buffer needs not have two areas and may have one area so that the output data is written into the same area after the input data is processed.

When a physical address of the input data is set, the DMAC 23 performs data transfer on the input data from the main memory 3 via the bus 6 based on the physical address. When a physical address of the output data is set, the DMAC 23 performs data transfer on the output data to the main memory 3 via the bus 6 based on the physical address. That is, the DMAC 23 forms a transferring unit configured to perform the processing of the DMA.

The DMAC 23 includes a register configured to be able to set data. When predetermined data is set to the register, the DMAC 23 is activated and the DMAC 23 performs the processing of the DMA. The DMAC 23 forms a setting unit, in which a physical address of the target data and a physical address of the result data are set as the physical address of the input data and the physical address of the output data of the DMA, respectively.

The I/F 24 includes a plurality of registers. The I/F 24 forms a registering unit configured to register contents of processing on the external register 4, a virtual address of target data, a virtual address of the output destination for the processed result to be output, and a process ID.

The computing unit 25 is a processing unit configured to perform the predetermined processing. The predetermined processing is image processing, encrypting processing and the like, for example. That is, the external device 4 is a device for performing a part of the processing in a program executed by the CPU 2, such as, for example, image processing, encrypting processing.

When predetermined data is set to the I/F 24, the computing unit 25 performs the predetermined processing. Specifically, the computing unit 25 sends a virtual address of the target data to the MMU 11 via the bus 6, obtains a physical address and management information corresponding to the virtual address from the MMU 11, while sending a virtual address of the result data to the MMU 11 via the bus 6 and obtaining a physical address and management information corresponding to the virtual address from the MMU 11. That is, the computing unit 25 forms a physical address obtaining unit configured to obtain the physical address and management information of each of the input data and the output data set to the DMAC 23 from the MMU 11, respectively.

Thus, the computing unit 25 obtains the physical addresses corresponding to the virtual addresses of the target data and the result data by inquiring of the MMU 11 the physical addresses, and sets the obtained physical addresses and management information to the DMAC 23 for the processing of the DMA. When predetermined data is set to the DMAC 23, the DMAC 23 is activated. The DMAC 23 reads out the target data in a specified address area in the main memory 3 based on the set physical address. The computing unit 25 of the external device 4 performs predetermined processing on the read out data. Then, the DMAC 23 writes the result data in the specified address area in the main memory 3 based on the set physical address.

(Entire Processing)

Typically, when the CPU 2 executes a program such as an application program, the CPU 2 inquires of the MMU 11a physical address corresponding to a virtual address of an execution program, obtains the physical address and management information of the main memory 3 from the MMU 11, and executes the program. If the information on the inquired physical address is not found in the TLB 12, an exception, i.e., an interruption occurs. As the memory manager program updates the contents of the TLB 12 under the control of the OS, the CPU 2 can execute the program by obtaining the physical address and the management information from the MMU 11 with updated contents. A process space of each program can be extended as a process ID is added to a virtual address, even if a plurality of programs are executed on the CPU 2. Thus, virtual addresses are distinguished between the programs.

If certain processing in the program executed by the CPU 2 is to be processed by the external device 4, the CPU 2 requests the external device 4 to perform the processing.

Therefore, the external device 4 executes predetermined processing with target data in a predetermined storage region 3a in the main memory 3 specified by the CPU 2 as input, and outputs the result data of the processing to a predetermined storage region 3b in the main memory 3 specified by the CPU 2.

After requesting the external device 4 to perform the predetermined processing, the CPU 2 suspends the processing of the program and executes other executable program. End of the processing of the external device 4 is notified using an interrupt signal, and in response to the notification, the suspended processing of the program is resumed.

When the CPU 2 requests the external device 4 to perform predetermined processing, a storage region on the main memory 3, to and from which the DMAC 23 inputs and outputs data, is specified by a driver program running on the CPU 2 that instructs the external device 4. The driver program performs setting, activation and termination of the processing on the external device 4. Specifically, the driver program can operate the external device 4 by writing predetermined data into the I/F 24.

(Processing in the External Device)

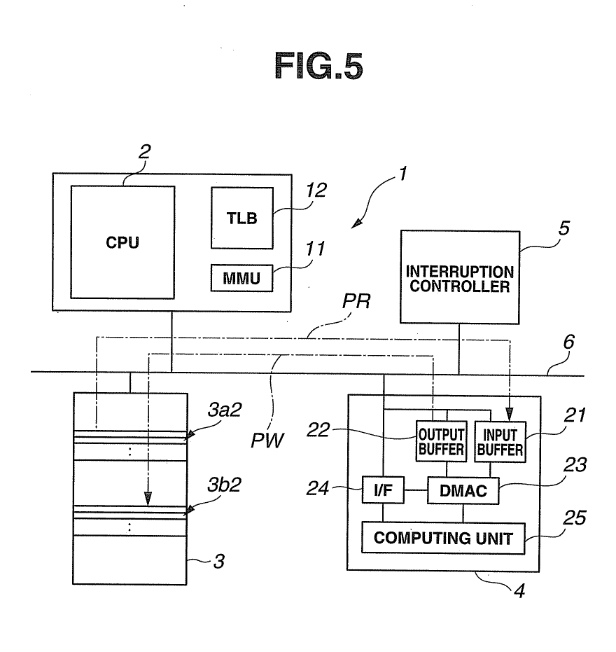

Now, operations of the information processing apparatus 1 in a case where a program requests the external device 4 to perform predetermined processing will be described with reference to FIG. 2 to FIG. 5. FIG. 2 to FIG. 5 are diagrams for illustrating a flow of processing by the external device in the information processing apparatus 1.

1) A Program Requests the External Device to Perform Processing

When the program running on the CPU 2 requests the external device 4 to perform predetermined processing, the CPU 2 sets, i.e., registers the information including:

(a) contents of processing (including the data size);

(b) a virtual address of object data in a process space;

(c) a virtual address at the output destination of the result data of the processing result in a process space; and

(d) a process ID of the program (identifier of the process) to the I/F 24. As the I/F 24 has a plurality of registers as mentioned above, the information is registered in the plurality of registers. As an arrow P1 on a dashed line in FIG. 1 indicates, the information is set from the CPU 2 to the I/F 24 via the bus 6.

Here, the process ID is an identifier of the program in the process space. When the data has been registered, the processing to be described later is performed by the external device 4. The program that uses the external device 4 can obtain the process ID of itself by sending a predetermined command to the OS, for example, before using the external device 4.

In the embodiment, description is made assuming that the size of the input data and the size of the output data are the same. If the sizes are different, the size of the output data needs to be specified or the size of the output data is unique to an algorithm of the processing to be executed.

2) Obtaining of a Physical Address for Reading Target Data in the External Device and Setting of the DMAC

As an arrow P2 on a dashed line in FIG. 2 indicates, the computing unit 25 of the external device 4 inquires of the MMU 11 at the CPU 2 side a physical address corresponding to the set virtual address (b) of the abovementioned target data by supplying information on the virtual address of the target data and the process ID (d) of the program to the MMU 11. This is for the external device 4 to obtain the arranged physical address of the target data and the management information (the page size and the page attribute) of the virtual page. The MMU 11 reads and obtains the physical address corresponding to the virtual address in a process space that is inquired and the management information of the virtual page by referencing the TLB 12. The corresponding physical address is a physical address corresponding to a virtual address of the top of the target data in the main memory 3.

As an arrow P3 on a dashed line in FIG. 2 indicates, the MMU 11 outputs the obtained physical address and the management information of the virtual page (including the page size and the page attribute) to the external device 4. The information on the page attribute includes permission information such as whether the virtual page is permitted to be read out or permitted to be written in as mentioned above.

As an arrow P4 on a dashed line in FIG. 2 indicates, the computing unit 25 of the external device 4 sets the DMAC 23 relating to reading of the target data based on the physical address and the page size obtained from the MMU 11. The DMAC 23 can perform the DMA that reads the target data page by page to be described later based on the set information.

If the inquired data is not found in the TLB 12, an exception occurs. The exception stops execution of a program running on the CPU 2 at that moment and the memory manager program which is a part of the OS is activated. Cooperation between the external device 4 and the OS in the exception is to be described later.

If the obtained page attribute indicates that reading of the virtual page is prohibited, the computing unit 25 of the external device 4 performs an error report by interruption to the CPU 2 via the interruption controller 5 as an arrow PI1 on a dashed line in FIG. 2 indicates.

3) Obtaining of a Physical Address Relating to Output of the Result Data and Setting of the DMAC in the External Device

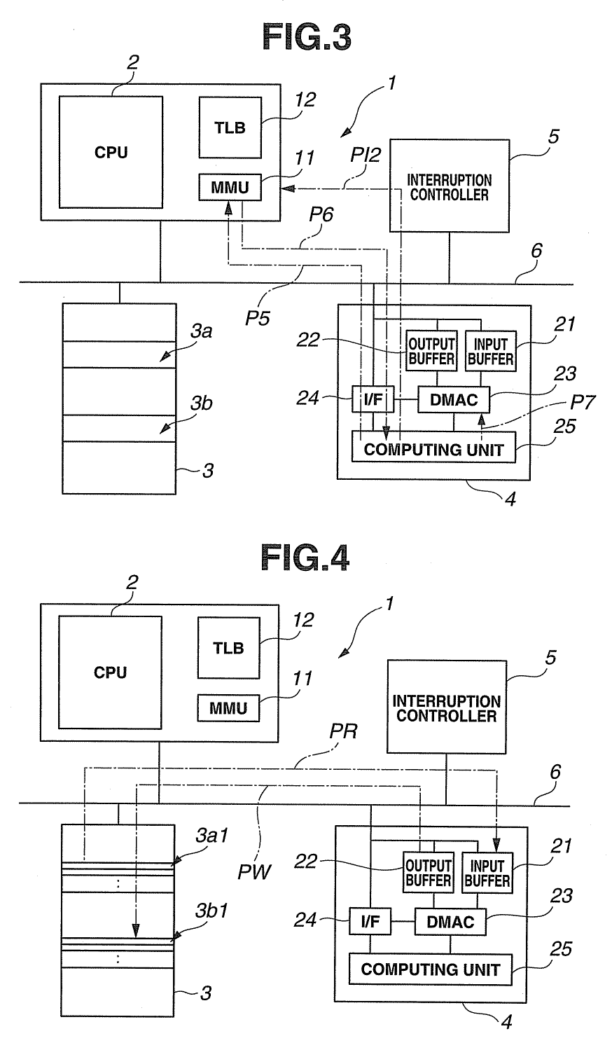

As an arrow P5 on a dashed line in FIG. 3 indicates, the computing unit 25 of the external device 4 inquires of the MMU 11 at the CPU 2 side a physical address corresponding to the set virtual address (c) at the output destination of the result data by supplying the virtual address of the result data and the process ID (d) of the program. This is for the external device 4 to obtain the physical address of the result data and the management information (the page size and the page attribute) of the virtual page. The MMU 11 reads and obtains the physical address corresponding to the virtual address in a process space that is inquired and the management information (the page size and the page attribute) of the virtual page by referencing the TLB 12. The corresponding physical address is a physical address corresponding to a virtual address of the top of the result data in the main memory 3 that is the transfer destination of the result data.

As an arrow P6 on a dashed line in FIG. 3 indicates, the MMU 11 outputs the obtained physical address and managing information on the virtual page (a page size, a page attribute) to the external device 4. Here, the information on the page attribute also includes whether the virtual page is permitted to be read out, whether the virtual page is permitted to be written and the like.

As an arrow P7 on a dashed line in FIG. 3 indicates, the computing unit 25 of the external device 4 performs setting relating to output of the result data to the DMAC 23 based on the physical address and the page size obtained from the MMU 11. The DMAC 23 can perform the DMA that outputs the result data page by page as described later based on the set information.

If data to be inquired is not found in the TLB 12, the exception also occurs in this case. The exception stops execution of a program running on the CPU 2 at that moment and the memory manager program of the OS is activated instead. Cooperation between the external device 4 and the OS in the exception is to be described later.

If the obtained page attribute indicates that writing of the virtual page is prohibited, the computing unit 25 of the external device 4 performs an error report by interruption to the CPU 2 via the interruption controller 5 as an arrow P12 on a dashed line in FIG. 3 indicates.

4) Processing of the DMA and Processing of the Computing Unit in the External Device

When the DMAC 23 detects that setting for input of the target data and output of the result data are performed, the predetermined processing requested by a program starts in the external device 4. Specifically, the DMAC 23 reads in order the target data from the specified storage region 3a of the main memory 3 by the DMA, executes the predetermined processing on the read out target data by the computing unit 25, and further outputs the result data to the specified data area 3b of the main memory 3 by the DMA.

Here, input of the target data from the main memory 3 and output of the result data into the main memory 3 are performed page by page from the top of the respective storage regions 3a and 3b. The computing unit 25 performs the predetermined processing on the input target data in order and outputs the result data to the specified storage region 3b in order.

The first reading of the target data is performed from the storage region 3a on the main memory 3 page by page. That is, the first reading of the target data is performed on the target data in a first page area 3a1 in the storage region 3a, in order from the top address of the target data. When the target data is read to the end of the page area 3a1 in the physical space during reading of the target data, the DMAC 23 stops the processing of the DMA and the processing of the computing unit 25 for reading, and the computing unit 25 performs resetting on the DMAC 23.

Specifically, the computing unit 25 inquires of the MMU 11a physical address of the top address of the virtual page corresponding to a next page area 3a2 in order to perform setting for reading the target data in the next page area 3a2 of the page area 3a1 for which the reading processing has performed in the physical space. The computing unit 25 of the external device 4 performs setting on the DMAC 23 for executing the DMA processing based on the physical address and the management information received from the MMU 11.

When the setting has performed, the computing unit 25 resumes the predetermined processing on the input target data. The DMAC 23 reads the next target data in the next page area 3a2 in the storage region 3a, in order from the top address of the page. When the target data is read to the end of the page area 3a2 in the physical space during reading of the target data, the DMAC 23 stops the processing of the DMA and the processing of the computing unit 25, and the computing unit 25 performs resetting on the DMAC 23.

Specifically, the computing unit 25 inquires of the MMU 11a physical address of the top address of the virtual page corresponding to a next page area 3a3 in order to perform setting for processing the target data in the next page area 3a3 of the page area 3a2 for which the reading processing has performed in the physical space. The computing unit 25 of the external device 4 performs setting for executing the DMA processing to the DMAC 23 based on the physical address and the management information received from the MMU 11.

When the setting has performed, the computing unit 25 resumes the predetermined processing. The DMAC 23 reads the next target data in the next page area 3a3 in the storage region 3a, in order from the top address.

Hereinafter, the predetermined processing by the computing unit 25 is performed while the DMAC 23 is reading the target data page by page in the abovementioned manner until the predetermined processing has been performed on all the target data.

On the other hand, the first output of the result data is performed from the storage region 3b on the main memory 3 page by page. That is, the output from the external device is performed on the obtained result data, which has been created by the computing unit 25 from the input data, in order from the top address in the output area at a first page area 3b1 in the storage region 3b. When the result data fills the end of the page area 3b1 in the physical space during output of the result data, the DMAC 23 stops the processing of the DMA and the processing of the computing unit 25 for reading and outputting, and the computing unit 25 performs resetting on the DMAC 23.

Specifically, the computing unit 25 inquires of the MMU 11a physical address of the top address of the virtual page corresponding to a next page area 3b2 in order to perform setting for outputting the result data to the next page area 3b2 of the page area 3b1 for which the output processing has performed in the physical space. The computing unit 25 of the external device 4 performs on the DMAC 23, resetting for resuming the DMA processing based on the physical address and the management information received from the MMU 11.

When the setting has performed, the processing of the DMA for reading and output is resumed and the computing unit 25 resumes the predetermined processing. The DMAC 23 outputs the next result data in order from the top address of the page area 3b2 in the storage region 3b. When the result data is output to the end of the page area 3b2 in the physical space during output of the result data, the DMAC 23 stops the processing of the DMA and the processing of the computing unit 25 for reading and output, and the computing unit 25 performs resetting on the DMAC 23.

Specifically, the computing unit 25 inquires of the MMU 11 a physical address of the top address of the virtual address of a next page area 3b3 in order to perform setting for outputting the result data to the next page area 3b3 of the page area 3b2 for which the output processing has performed in the physical space. The computing unit 25 of the external device 4 performs on the DMAC 23, resetting for executing the DMA processing based on the physical address and the management information received from the MMU 11. Then, the DMAC 23 outputs the next result data to the next page area 3b3 in the storage region 3b in order from the top address.

Hereinafter, the DMAC 23 outputs the processing result data page by page in the abovementioned manner until the output processing has been performed on all the result data.

The DMA is reset based on whether a page boundary of the physical address is reached or not because data may be divided into discontinuous pages in the physical space even if the data is in continuous areas on the virtual address.

As mentioned above, when the target data is read out page by page to the page boundary by the DMA performed in the external device 4, data processing of the computing unit 25 is paused in order to update the setting of the DMAC 23. When the page boundary is detected during output of the result data, processing of the DMA for reading the target data is stopped, the MMU is inquired of information at the output side, and resetting at the output side is performed.

5) Exception Handling in the CPU

If a virtual address inquired from the external device 4 is not found in the TLB 12, an exception is occurred as mentioned above. The exception stops execution of a program running on the CPU 2 at that moment and the memory manager program of the OS is activated.

Prior to describing the exception, configuration of the MMU 11 and operations of the MMU 11 will be described first.

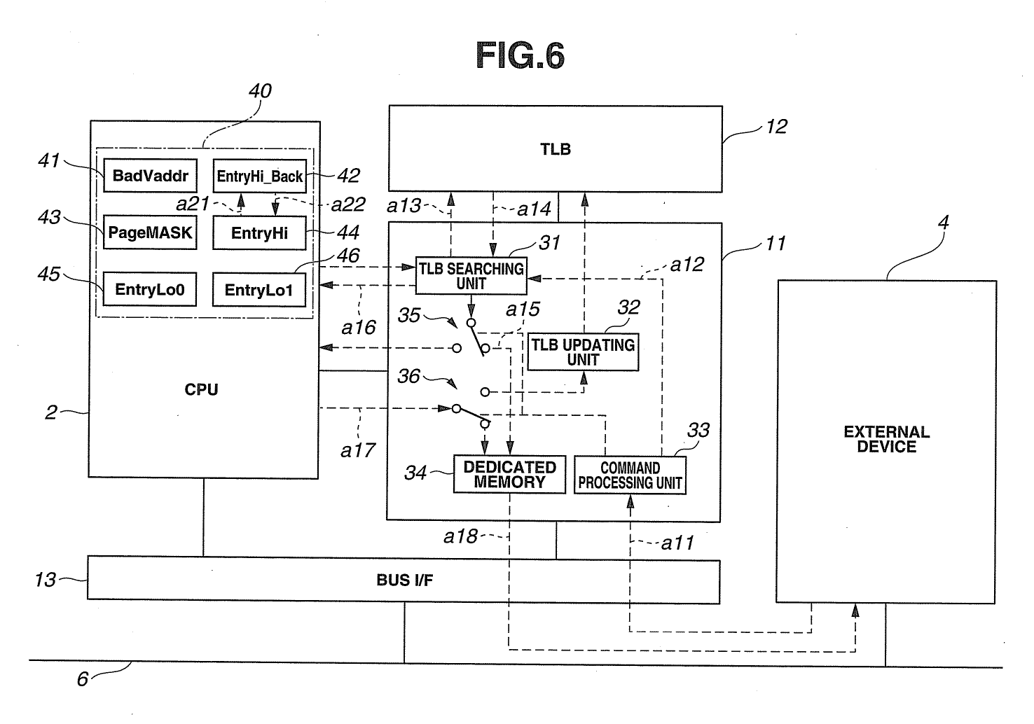

FIG. 6 is a configuration diagram showing configuration of the information processing apparatus with the main memory 3 and the interruption controller 5 omitted for illustrating configuration of the MMU 11. Compared with FIG. 1, FIG. 6 shows the components to form the MMU 11 in more details. As shown in FIG. 6, the CPU 2 and the MMU 11 are each connected to the bus 6 via the bus I/F 13. The MMU 11 is also connected to the CPU 2 and the TLB 12. In FIG. 6, a dotted line with an arrow indicates a flow of each signal. The flow of each signal will be described later.

The MMU 11 includes a TLB searching unit 31, a TLB updating unit 32, a command processing unit 33, and a dedicated memory 34. The MMU 11 has two switches 35 and 36.

The TLB searching unit 31 is a circuit configured to obtain a physical address corresponding to the supplied virtual address by searching the contents of the TLB 12. The TLB updating unit 32 is a circuit configured to update the contents of the TLB 12. The command processing unit 33 is a circuit configured to process a command received via the bus 6. Each of the switches 35 and 36 is a switch configured to switch options based on an instructing signal from the command processing unit 33. The switch 35 is a switch configured to switch whether the information searched and obtained by the TLB searching unit 31 is to be output to the CPU 2 or to the dedicated memory 34. The switch 36 is a switch configured to switch whether the TLB updating signal from the CPU 2 is to be output to the TLB updating unit 32 or to the dedicated memory 34.

The command processing unit 33, when receiving a command for inquiring a physical address, outputs a searching signal to the TLB searching unit 31. The command processing unit 33 outputs to the switch 35 an instructing signal for switching the searched result of the TLB searching unit 31 into a state to be output to the dedicated memory 34 (the state shown in FIG. 6). The command processing unit 33 further outputs to the switch 36, an instructing signal for switching the TLB updating signal from the CPU 2 into a state to be output to the dedicated memory 34 (the state shown in FIG. 6).

The switch 35 is usually in a state in which the searched result of the TLB searching unit 31 is output to the CPU 2. The switch 36 is usually in a state in which the TLB updating signal from the CPU 2 is output to the TLB updating unit 32.

The CPU 2 has a group of registers 40 for writing the TLB. The group of registers 40 includes a BadVaddr register 41, an EntryHi_Back register 42, a PageMASK register 34, an EntryHi register 44, an EntryLo0 register 45, and an EntryLo1 register 46. Each register stores various type of data under control of the CPU 2.

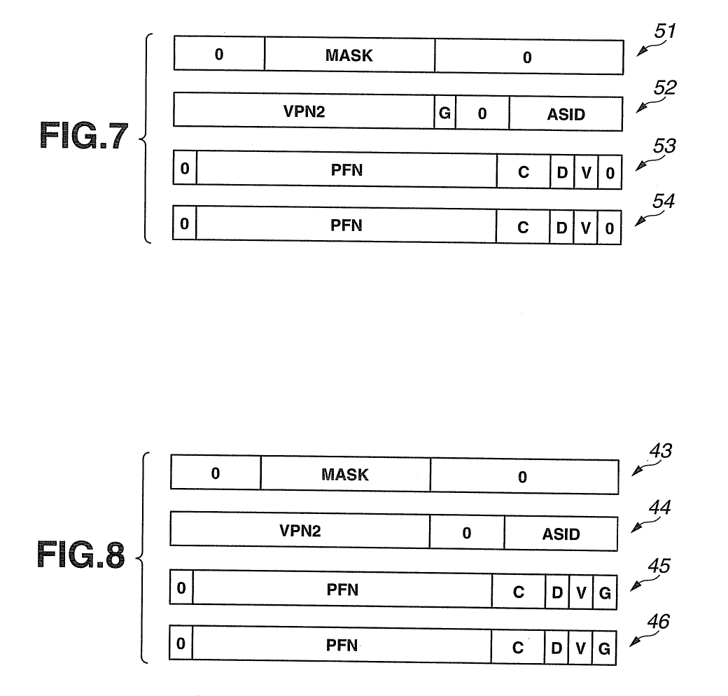

Information to be registered or stored in the TLB 12 will be described. The TLB 12 has a plurality of entry parts for registering information on a plurality of physical addresses respectively corresponding to a plurality of virtual addresses. FIG. 7 is a diagram showing a format of information to be registered in each entry part of the TLB 12.

The information to be registered in each entry part of the TLB 12 includes four parts 51, 52, 53, 54. The first part 51 includes two data strings of ‘0’ and ‘MASK’ data arranged between the two data strings. ‘MASK’ is data for specifying the size of the page.

The second part 52 includes ‘VPN2’ data, ‘G’ data, a data string of ‘0’, and ‘ASID’ data. ‘VPN2’ is data corresponding to the top address of the virtual page. ‘G’ data is bit data that is a global bit and can invalidate ‘ASID’ data corresponding to the process ID. ‘ASID’ data is data corresponding to the process ID.

The third and fourth parts 53, 54 include data of ‘0’, ‘PFN’ data, ‘C’ data, ‘D’ data, ‘V’ data. ‘PFN’ data is data corresponding to the top physical address of even numbered pages in the third part 53. In the fourth part 54, ‘PEN’ data is data corresponding to the top physical address of odd-numbered page. Here, as even numbered pages and odd numbered pages are managed in one entry part, PFN or the like are present by the number of two. ‘C’ data is data for deciding an attribute of the data cache in the page. ‘D’ data is bit data for permitting writing into the page. When data to be protected such as a code is arranged, ‘D’ data is set to ‘0’ to prohibit writing. ‘V’ data is bit data for enabling the page. When ‘0’ is set to ‘V’ data, the setting of the page (PFN, C, D and the like) is invalidated and not referenced.

Among the abovementioned entry parts of the TLB 12, four registers of the PageMASK register 43, the EntryHi register 44, the Entry Lo register 45 and the EntryLo1 register 46 make interfaces for updating or reading information.

FIG. 8 is a diagram showing contents of information in the PageMASK register 43, the EntryHi register 44, the EntryLo0 register 45, and the EntryLo1 register 46.

The set of the registers, PageMASK register 43, the EntryHi register 44, the EntryLo0 register 45, and the EntryLo1 register 46, acts as an interface for an entry part of the TLB 12; by specifying the entry with a dedicated method, the content of the TLB entry can be referred and/or modified via the interface.

When a usual inquiry is made from the CPU 2 about a physical address, the TLB searching part 31 searches the TLB 12, and supplies the physical address obtained by the searching and the management information to the CPU 2 via the switch 35.

In response to the inquiry from the CPU 2 about the physical address, the TLB searching unit 31 searches the TLB 12, and if the corresponding physical address is not found in the TLB 12 as a result of the searching, the TLB searching unit 31 generates a signal (a16) which causes an exception to enforce a TLB refill operation by activating the memory management program of the OS. The memory manager program of the OS extracts information on the corresponding physical address that was not found in the TLB 12 from the information managed by the memory manager, and outputs to the TLB updating unit 32a TLB writing signal for instructing the updating processing of the TLB 12 based on the extracted information.

The memory manager program writes information on the corresponding physical address that was not found in the TLB 12 into the four registers of the PageMASK register 43, the EntryHi register 44, the EntryLo0 register 45, and the EntryLo1 register 46. The TLB updating unit 32 updates the contents of the TLB 12 by using the information written in the four registers.

As a result of the TLB 12 updated, the CPU 2 can obtain the information on the requested physical address from the TLB searching unit 31.

As mentioned above, the CPU2 can obtain the information on the physical address from the MMU 11.

Now, a case where the external device 4 inquires the physical address will be described. As mentioned above, the MMU 11 not only provides a physical address to the CPU2 but also provides the physical address to the external device 4 connected the bus 6. The reference numerals and characters in parentheses in the description below are reference numerals and characters for identifying the dotted lines indicating flows of signals in FIG. 6.

First, the command processing unit 33 accepts a command for requesting a physical address from the external device 4 via the bus 6 (a11). The command processing unit 33 outputs to the TLB searching unit 31 a signal for searching information corresponding to the virtual address in the process space specified by the external device 4 (a12). The TLB searching unit 31 searches the TLB 12 (a13). The TLB searching unit 31 obtains a search result (a14). When an entry part including the corresponding information is found, the TLB searching unit 31 reads the setting and saves the setting in the dedicated memory 34 in the MMU 11 (a15).

If any entry part including the corresponding information is not found on the TLB 12, the TLB searching unit 31 generates a signal (a16) which causes the exception to enforce the TLB refill operation by activating the memory manager program of the OS. Here, the CPU saves the contents of the EntryHi register 44 to the EntryHi_Back register 42 (a21), and sets the virtual address, which is inquired from the external device 4, to the BadVaddr register 41. ASID, which is corresponding to the process ID of the program utilizing the function of the external device, is set in the EntryHi register 44. When the CPU 2 is performing exception handling, that processing mentioned above is delayed. If the exception handling occurs, the invoked memory manager program generates and outputs information for rewriting the TLB. Here, the memory manage program does not recognize whether the exception is caused by a program or the external device.

Because the switch 36 is switched to the dedicated memory 34 side, the result of the TLB updating processing by the OS is not reflected on the TLB 12 but saved in the dedicated memory 34 in the MMU 11 (a17). That is, the MMU 11 blocks the information from being written into the TLB 12 and outputs the information to the external device 4 instead of the TLB 12. Accordingly, the OS needs not to be changed.

The saved contents of the EntryHi register 44 is restored from the EntryHi_Back register 42 to the EntryHi register 44 in conjunction with resuming process from the exception handling of the OS (a22).

The MMU 11 reads out from the dedicated memory 34 a physical address (calculated from the PFN) corresponding to the virtual address in the process space specified by the external device 4, the page size (corresponding to the MASK), and the page attribute (corresponding to ‘D’ data in the abovementioned example) and outputs them to the external device 4, which inquired them (a18). That is, the MMU 11 blocks writing into the TLB 12 by the OS, generates a physical address, extracts information on the page size, and management i.e., attribute of the page from the blocked data and notifies the external device 4 of them via the bus 6.

The external device 4 executes the DMA processing necessary in the predetermined processing based on the information received from the CPU 2 side (a physical address corresponding to a top virtual address at the transfer source, unit for managing a page (size), permission in the virtual space in the self-process).

Here, if the target virtual page is ‘reference prohibited (alteration prohibited in outputting data)’, the DMAC 23 outputs error information without performing the DMA processing. The external device 4 notifies the CPU 2 of the occurring error as an interruption. That is, the external device 4 has functions of determining whether the DMA processing is available or not based on the management information on the object page notified from the MMU 11 via the bus 6 and notifying the CPU 2 of the error by using an interruption in the case that the DMA processing is unavailable.

The external device 4 determines, based on the notified page size, whether the data necessary for the predetermined processing can be completely processed or not in an amount of the transferring size in the same page. If the target data is contained in the same page, the reading by the DMA completes in one go in the DMA processing. If the target data is not contained in the same page, the reading by the DMA is divided into a plurality of occasions. Here, the external device 4 obtains the information required as mentioned above by inquiring of the MMU 11 again the information on the physical address relating to the virtual address of the area to be processed next without generating an interruption when the first DMA processing ends. That is, the virtual addresses and the physical addresses in the process space are repeatedly exchanged between the external device 4 and the MMU 11 until the DMA transfer completes.

As mentioned above, the external device 4 connected to the bus 6 along with the CPU 2 has the DMAC 23 dedicated for inputting and outputting data. A virtual address in the process space, which is managed by the OS on the CPU 2, is specified to the I/F 24 as an address of the data. The external device 4 can coordinate with the OS on the CPU 2 via the MMU 11, which is a function of the CPU 2, to obtain a physical address corresponding to the specified virtual address in the process space and perform the DMA. The external device 4 further executes memory access according to the attribute given by the OS to the virtual address in the process space.

The external device 4 calculates an accessible data size from the page size notified from the MMU 11 via the bus 6, autonomously stops the DMA processing at the page boundary, further outputs to the MMU 11 via the bus 6 a request of converting the virtual address of the target data into the physical address for continuing the DMA processing, and, on receiving a response, performs a request of the other virtual address, execution of the DMA processing and detection of an error and an interruption.

As a result, according to the embodiment, overhead such as copying of data required in using the external device 4, which is the information processing apparatus other than the CPU 2, reservation of a work area dedicated for the external device and the like is enabled in such an intelligent OS as the UNIX. A memory protection function by the MMU 11 can be also reflected on operations of the external device 4. If a part of an existing program is altered and replaced for the processing by the external device 4, the alteration of the program can be minimized.

As mentioned above, the embodiment can provide an information processing apparatus and a method for the same that reduce the overhead of the CPU for performing the processing using the external device and corporate with the memory management mechanism in the OS.

In conventional arts, as mentioned above, when a part of processing of a program is shared with an external device input/output buffer areas for the external device need to be obtained on a main memory and the areas need to be continuous on a physical address. In such a case, there is also such overhead as copying target data into an input buffer area for the external device in advance, and after the processing by the external device is finished, copying the target data from an output buffer area for the external device into an area in a process space specified by the program.

In the embodiment, however, when a part of processing of a program is shared with an external device, reservation of an area and such processing as copying or the like on data as in conventional art are not required. That improves the usage efficiency of the main memory and the performance of the entire information processing apparatus.

Moreover, the program needs not to identify where the area in a process space, on which the target data is arranged, is located in a physical space and how the target data is divided. Since the program can use the external device without any processing of converting a virtual address into a physical address for the processing of the external device, it is possible to minimize alteration on the program when partial processing is implemented by the external device.

Furthermore, because the DMAC in the external device implements inputting and outputting of data based on information provided by the MMU, the embodiment can reduce input from a memory space without access authority or output into a memory space without access authority so as to achieve memory protection in cooperation with a kernel of the OS. In addition, since the embodiment can directly specify a virtual address in a process space in controlling the external device, it is possible to minimize the alteration of a software program when a part of an existing software program is assigned to the external device.

The present invention is not limited to the abovementioned embodiments and various alterations and modifications are possible to the present invention without departing from the spirit of the present invention.

What is claimed is:

1. An information processing apparatus comprising:
a central processing unit;
a memory connected to the central processing unit via a bus;
an external processing device connected to the central processing unit and the memory via the bus and configured to execute predetermined processing;
an address converting unit configured to output a physical address of the memory corresponding to a virtual address of a process to be executed in the central processing unit when the virtual address is input;
a transferring unit provided in the external processing device, the transferring unit being configured to perform data transfer of input data from the memory based on the physical address of the memory set as the physical address of the input data and perform data transfer of output data to the memory based on the physical address of the memory set as the physical address of the output data;
a physical address obtaining unit configured to obtain the physical address corresponding to the virtual address of target data of the predetermined processing from the address converting unit and obtain the physical address corresponding to the virtual address of result data of the predetermined processing from the address converting unit; and
a setting unit configured to set the physical address of the target data and the physical address of the result data obtained by the physical address obtaining unit as the physical address of the input data and the physical address of the output data for the data transferring unit, respectively.

2. The information processing apparatus according to claim 1, wherein
the physical address obtaining unit supplies information on an identifier of the process added to the virtual address of the target data and the virtual address of the result data to the address converting unit, and obtains the physical address of the target data and the physical address of the result data from the address converting unit.

3. The information processing apparatus according to claim 1, wherein
the physical address obtaining unit obtains information on page size of a virtual page of the virtual address from the address converting unit,
the obtained information on page size is set to the setting unit, and
the transferring unit performs the data transfer of the input data from the memory and the data transfer of the output data to the memory on the basis of the set page size.

4. The information processing apparatus according to claim 2, wherein
the physical address obtaining unit obtains information on page size of the virtual page of the virtual address from the address converting unit,
the obtained information on page size is set to the setting unit, and
the transferring unit performs the data transfer of the input data from the memory and the data transfer of the output data to the memory on the basis of the set page size.

5. The information processing apparatus according to claim 3, wherein
the external processing device performs the predetermined processing on the page basis,
the physical address obtaining unit obtains the physical address of the target data from the address converting unit and obtains the physical address of the result data from the address converting unit on the page basis, and
the setting unit sets the obtained physical addresses of the target data and the result data respectively as the physical address of the input data and the physical address of the output data for the data transferring unit on the page basis.

6. The information processing apparatus according to claim 4, wherein
the external processing device performs the predetermined processing on the page basis,
the physical address obtaining unit obtains the physical address of the target data from the address converting unit and obtains the physical address of the result data from the address converting unit on the page basis, and
the setting unit sets the obtained physical addresses of the target data and the result data respectively as the physical address of the input data and the physical address of the output data for the data transferring unit on the page basis.

7. The information processing apparatus according to claim 1, wherein
the address converting unit outputs information on permission of the virtual address along with information on the physical address, and
the physical address obtaining unit causes the central processing unit to handle interruption when the information on the obtained virtual address indicates access prohibition.

8. The information processing apparatus according to claim 1, wherein
the address converting unit outputs information on the physical address corresponding to the input virtual address by referencing a correlation table between the virtual address and the physical address.

9. The information processing apparatus according to claim 8, comprising
a memory management unit configured to perform rewriting processing to rewrite contents of the correlation table to include information on the physical address corresponding to the input virtual address that is not present in the correlation table when the information on the physical address is not present, wherein
the address converting unit does not cause the memory management unit to perform the rewriting processing on the contents of the correlation table when the address converting unit outputs the information on the physical address in response to an inquiry from the physical address obtaining unit.

10. An information processing method in an information processing apparatus having a central processing unit, a memory connected to the central processing unit via a bus, an external processing device connected to the central processing unit and the memory via the bus and configured to execute predetermined processing, an address converting unit configured to output a physical address of the memory corresponding to a virtual address when the virtual address of a process to be executed in the central processing unit is input, and a transferring unit provided in the external processing device, configured to perform data transfer of input data from the memory based on the physical address of the memory set as the physical address of the input data and perform data transfer of output data to the memory based on the physical address of the memory set as the physical address of the output data; the method comprising:
obtaining the physical address corresponding to the virtual address of target data of the predetermined processing from the address converting unit;
obtaining the physical address corresponding to the virtual address of result data of the predetermined processing from the address converting unit;
setting the physical address of the obtained target data and the physical address of the result data respectively as the physical address of the input data and the physical address of the output data;
performing by the transferring unit data transfer of the input data from the memory based on the physical address of the memory set as the physical address of the input data; and
performing by the transferring unit data transfer of the output data to the memory based on the physical address of the memory set as the physical address of the output data.

11. The information processing method according to claim 10, wherein
the physical address of the target data and the physical address of the result data are obtained from the address converting unit by supplying the address converting unit with information on an identifier of the process added to the virtual address of the target data and the virtual address of the result data.

12. The information processing method according to claim 10, comprising
obtaining information on page size of the virtual page of the virtual address from the address converting unit,
setting the obtained information on page size, and
performing by the transferring unit the data transfer of the input data from the memory and the data transfer of the output data to the memory on the basis of the set page size.

13. The information processing method according to claim 11, comprising
obtaining information on page size of the virtual page of the virtual address from the address converting unit,
setting the obtained information on page size, and
performing by the transferring unit the data transfer of the input data from the memory and the data transfer of the output data to the memory on the basis of the set page size.

14. The information processing method according to claim 12, wherein the external processing device
performs the predetermined processing on the page basis,
obtains the physical address of the target data from the address converting unit on the page basis,
obtains the physical address of the result data from the address converting unit on the page basis, and
sets the obtained physical addresses of the target data and the result data respectively as the physical address of the input data and the physical address of the output data for the data transferring unit on the page basis.

15. The information processing method according to claim 13, wherein the external processing device
performs the predetermined processing on the page basis,
obtains the physical address of the target data from the address converting unit on the page basis,
obtains the physical address of the result data from the address converting unit on the page basis, and
sets the obtained physical addresses of the target data and the result data respectively as the physical address of the input data and the physical address of the output data for the data transferring unit on the page basis.

16. The information processing method according to claim 10, wherein the address converter
outputs information on permission of the virtual address along with information on the physical address, and
the central processing unit handles interruption when the information on the obtained virtual address indicates access prohibition.

17. The information processing method according to claim 10, wherein
the address converting unit outputs information on the physical address corresponding to the input virtual address by referencing a correlation table between the virtual address and the physical address.

18. The information processing method according to claim 17, wherein
rewriting processing is performed to rewrite contents of the correlation table to include information on the physical address corresponding to the input virtual address that is not present in the correlation table when the information on the physical address is not present, and
the address converting unit does not perform the rewriting processing on the contents of the correlation table when the address converting unit outputs the information on the physical address in response to an inquiry from the external processing device.
